(19) United States
(12) Patent Application Publication
(10) Pub. No.: US 2016/0227595 A1
(43) Pub. Date: Aug. 4, 2016

(54) WIRELESS COMMUNICATION CONTROL METHOD AND WIRELESS COMMUNICATION CONTROL SYSTEM

(71) Applicant: Panasonic Intellectual Property Management Co., Ltd., Osaka (JP)

(72) Inventors: Hiroki SUNAGAWA, Osaka (JP); Toru OIZUMI, Kanagawa (JP); Takeshi HATAKEYAMA, Osaka (JP); Yoshifumi ASAO, Hyogo (JP)

(21) Appl. No.: 15/002,118

(22) Filed: Jan. 20, 2016

(30) Foreign Application Priority Data
Feb. 4, 2015 (JP) 2015-020502

(51) Int. Cl. H04W 76/02; H04W 4/00; H04W 72/08

(52) U.S. Cl. CPC H04W 76/023; H04W 72/082; H04W 4/008; H04W 88/04

(57) ABSTRACT

A wireless communication control method of the present disclosure is a wireless communication control method controlling communication between a first wireless communication apparatus, and a first external device and controlling communication between a second wireless communication apparatus and a second external device, by a server apparatus, the method including receiving a connection request to the first external device from the first wireless communication apparatus, and causing the first external device to connect with the second wireless communication apparatus if the second wireless communication apparatus has been connected with the second external device upon receiving the connection request.

### BACKGROUND OF THE INVENTION

1. Field of the Invention

The present disclosure relates to a wireless communication control method and a wireless communication control system that is able to be used in an airplane, a train, and the like.

2. Description of the Related Art

PTL 1 discloses a communication system in which a communication unit provided to each seat of the airplane connects with a terminal owned by a passenger and communicates with the terminal. The communication unit is able to communicate with the terminal owned by the passenger via Bluetooth (registered trademark) which is one of short range wireless communication standards.

### CITATION LIST

### Patent Literature

PTL 1: Unexamined Japanese Patent Publication No. JP2002-359710

### SUMMARY OF THE INVENTION

The present disclosure provides a wireless communication control method that improves communication quality by reducing interference between wireless communication apparatuses in a situation in which there is a plurality of wireless communication apparatuses.

The wireless communication control method of the present disclosure is a wireless communication control method controlling communication between a first wireless communication apparatus and a first external device, and controlling communication between a second wireless communication apparatus and a second external device, by a server apparatus, the method including receiving a connection request to the first external device from the first wireless communication apparatus, and causing the first external device to connect with the second wireless communication apparatus if the second wireless communication apparatus has been connected with the second external device upon receiving the connection request.

The wireless communication control method of the present disclosure is able to improve the communication quality by reducing the interference between the wireless communication apparatuses in the situation in which there is the plurality of wireless communication apparatuses.

### BRIEF DESCRIPTION OF DRAWINGS

FIG. 1 is a diagram describing an arrangement of on-board monitors in an airplane in a first exemplary embodiment;

FIG. 2 is a diagram describing a grouping of the on-board monitors in the airplane in the first exemplary embodiment;

FIG. 3 is a block diagram of a wireless communication system in the first exemplary embodiment;

FIG. 4 is a block diagram of a server apparatus in the first exemplary embodiment;

FIG. 5 is a diagram illustrating grouping information in the first exemplary embodiment;

FIG. 6 is a diagram illustrating connection information in the first exemplary embodiment;

FIG. 7 is a block diagram of an on-board monitor in the first exemplary embodiment;

FIG. 8 is a diagram describing connection of a smartphone with an on-board monitor in the first exemplary embodiment;

FIG. 9 is a diagram illustrating the connection information after the first time update in the first exemplary embodiment;

FIG. 10 is another diagram describing connection of the smartphone with the on-board monitor in the first exemplary embodiment;

FIG. 11 is a diagram illustrating the connection information after the second time update in the first exemplary embodiment;

FIG. 12 is a flowchart describing the connection of the smartphone with the on-board monitor in the first exemplary embodiment; and

FIG. 13 is a block diagram of a wireless communication system in a second exemplary embodiment.

### DETAILED DESCRIPTION OF THE PREFERRED EMBODIMENTS

Exemplary embodiments are described in detail below with appropriate reference to drawings. However, an unnecessarily detailed description may be omitted. For example, a detailed description of an already well known matter and a duplicate description for substantially the same configuration may be omitted. This is to avoid the unnecessarily redundant description below, and to facilitate understanding of those skilled in the art.

Incidentally, accompanying drawings and the description below are provided so that those skilled in the art sufficiently understand the present disclosure, and are not intended to limit the claimed subject matter.

### First Exemplary Embodiment

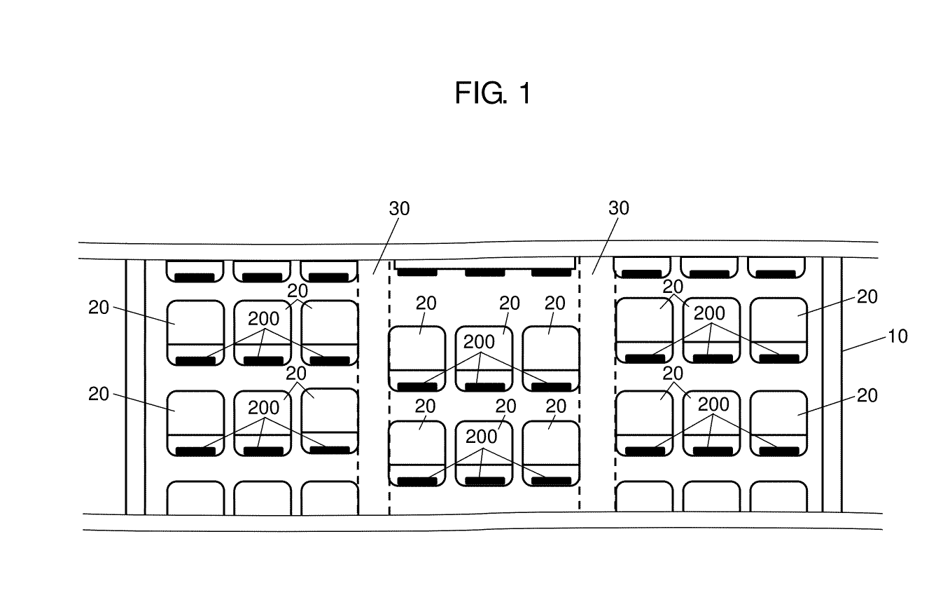

A first exemplary embodiment is described below with reference to FIG. 1 to FIG. 12.

[1-1. Arrangement of on-Board Monitor in Airplane]

FIG. 1 is a diagram describing an arrangement of on-board monitors in an airplane in a first exemplary embodiment. In FIG. 1, on-board monitor 200 is located for each seat 20 of a passenger inside airplane 10. On-board monitor 200 is located on a backrest of seat 20 or a cabin wall of airplane 10. In addition, aisle 30 is provided inside airplane 10.

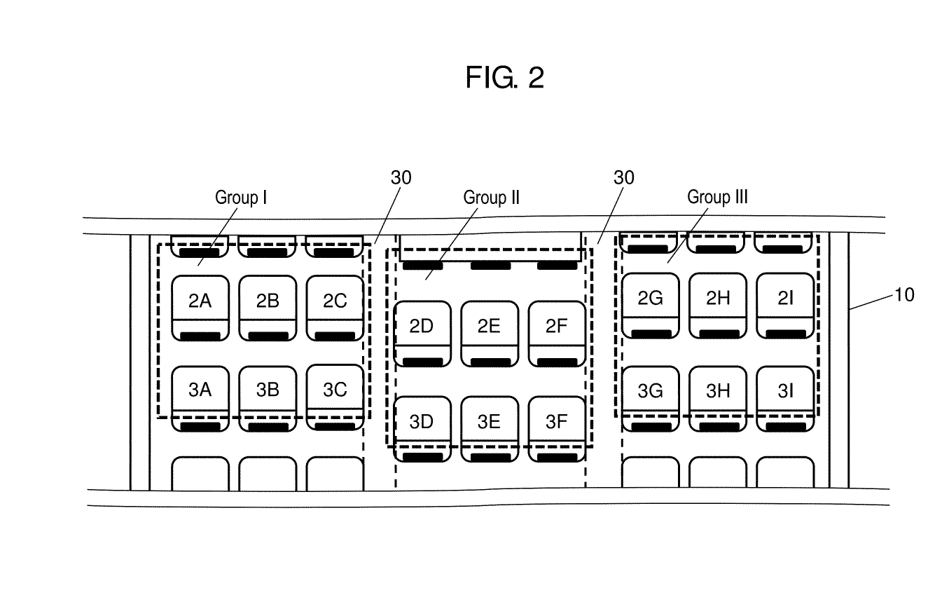

FIG. 2 is a diagram describing a grouping of on-board monitor 200 in airplane 10 in the first exemplary embodiment. Adjacent six on-board monitors 200 are grouped. In FIG. 2, six on-board monitors 200 located at the seats of seat numbers “2A,” “2B,” “2C,” “3A,” “3B,” “3C” are grouped as “group I,” and six on-board monitors 200 located at the seats of seat numbers “2D,” “2E,” “2F,” “3D,” “3E,” “3F” are grouped as “group II,” and six on-board monitors 200 located at the seats of seat numbers “2G,” “2H,” “2I,” “3G,” “3H,” “3I” are grouped as “group III.”

It is desirable that on-board monitors 200 are grouped so that a distance between all on-board monitors 200 is up to about 10 m that is connectable, which is defined by Bluetooth Class2 used in smartphone 300. In addition, inside airplane 10, it is desirable that on-board monitors 200 are grouped not to sandwich aisle 30, to reduce obstacles as much as possible. Specifically, it is desirable that any two on-board monitors 200 in a same group are located without separating by aisle 30 or that multiple on-board monitors 200 in the same group are located without separating by aisle 30.

### [1-2. Configuration of Wireless Communication System]

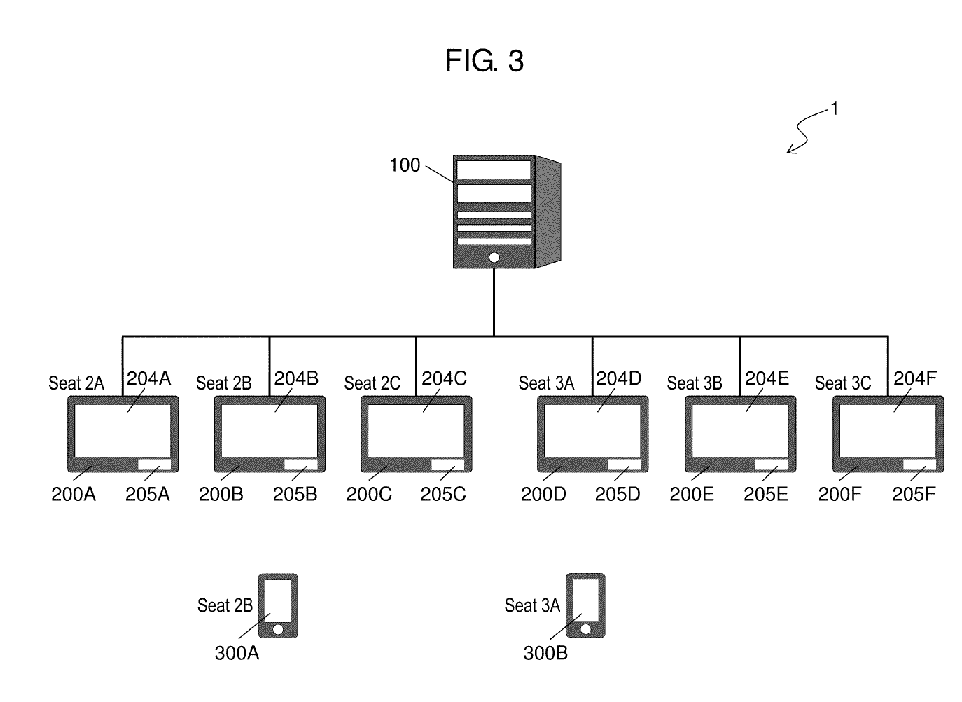

Next, as an example, a wireless communication system is described including on-board monitor 200 grouped in “group I.” FIG. 3 is a block diagram of a wireless communication system in the first exemplary embodiment. Wireless communication system 1 in FIG. 3 includes server apparatus 100, and on-board monitors 200A, 200B, 200C, 200D, 200E, 200F. On-board monitor 200A is located at the seat number “2A;” on-board monitor 200B is located at the seat number “2B;” on-board monitor 200C is located at the seat number “2C;” on-board monitor 200D is located at the seat number “3A;” on-board monitor 200E is located at the seat number “3B;” on-board monitor 200F is located at the seat number “3C.”

In addition, a passenger of the seat number “2B” owns smartphone 300A, and a passenger of the seat number “3A” owns smartphone 300B.

Server apparatus 100 is connected with each of on-board monitors 200A-200E via a network cable, and establishes bidirectional communication such as distribution of contents and acquisition of sensor information from each of onboard monitors 200A-200E, with each of on-board monitors 200A-200E. Information such as communication connection situation of each of on-board monitors 200A-200E is collectively managed by server apparatus 100.

Each of on-board monitors 200A-200E is able to reproduce the contents distributed from server apparatus 100 and to communicate with external devices such as smartphone 300A, 300B owned by the passengers, and the like.

On-board monitor 200A includes touch panel 204A and Bluetooth module 205A. On-board monitor 200B includes touch panel 204B and Bluetooth module 205B. On-board monitor 200C includes touch panel 204C and Bluetooth module 205C. On-board monitor 200D includes touch panel 204D and Bluetooth module 205D. On-board monitor 200E includes touch panel 204E and Bluetooth module 205E. On-board monitor 200F includes touch panel 204F and Bluetooth module 205F.

Hereinafter, on-board monitors 200A-200F are collectively referred to as on-board monitor 200. Elements included in on-board monitor 200 such as touch panels 204A-204F and Bluetooth modules 205A-205F are in the same manner. Touch panels 204A-204F are collectively referred to as touch panel 204, and Bluetooth modules 205A-205F, are collectively referred to Bluetooth module 205. In addition, smartphones 300A, 300B are collectively referred to as smartphone 300.

Incidentally, in the present exemplary embodiment, six on-board monitors 200 connected with server apparatus 100 are described as one group; however, a number of on-board monitors 200 of one group is not limited to this and may be any number. In addition, a case is described when a number of smartphones owned by the passengers is two; however, the number of smartphones is not limited to this and may be any number. On-board monitor 200 is an example of wireless communication apparatuses.

Each of smartphones 300A, 300B owned by the passengers includes a wireless communication module, and is able to establish bidirectional communication with on-board monitor 200 wirelessly. Smartphone 300 is an example of the external devices.

### [1-3. Configuration of Server Apparatus]

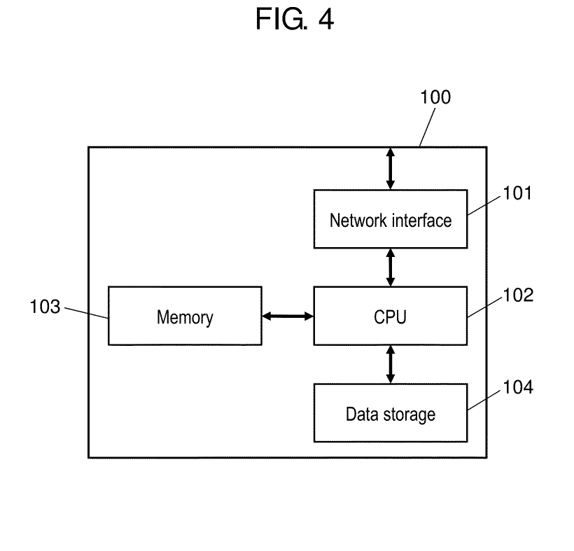

Next, a configuration of server apparatus 100 is described. FIG. 4 is a block diagram of server apparatus 100 in the present exemplary embodiment. Server apparatus 100 includes network interface 101, Central Processing Unit (CPU) 102, memory 103, and data storage 104.

Network interface 101 is an interface by which CPU 102 communicates with on-board monitor 200 via the network cable.

CPU 102 executes programs stored in memory 103 to be described later to perform various operations and information processing. CPU 102 is able to read from memory 103 or data storage 104 and write to memory 103 or data storage 104. In addition, CPU 102 communicates with on-board monitor 200 via network interface 101. CPU 102 detects a connection request via Bluetooth to connect with on-board monitor 200 by smartphone 300, and issues a search command to on-board monitor 200 according to operation to be described later.

Memory 103 stores the programs executed by CPU 102 and operation results of CPU 102. Memory 103 is composed of a flash memory or a Random

Access Memory (RAM).

Data storage 104 stores the contents to be distributed to on-board monitor 200, and grouping information and connection information of on-board monitor 200 to be described later. Data storage 104 is composed of a hard disk and the like.

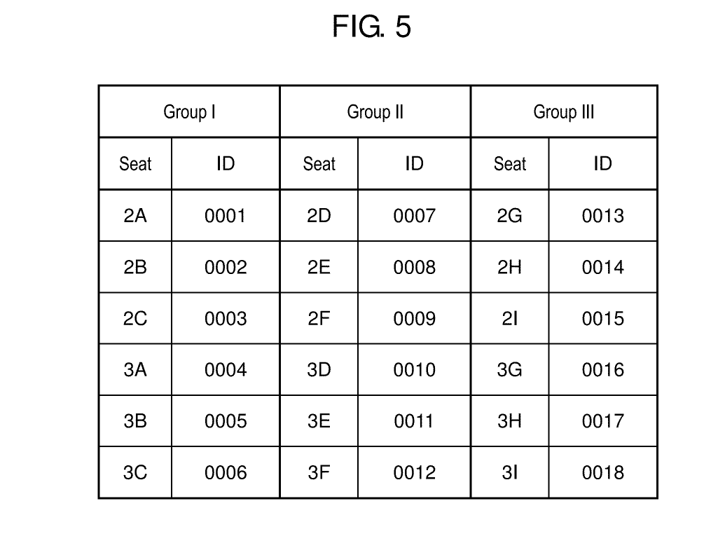

Next, the grouping information is described. FIG. 5 is a diagram illustrating the grouping information in the present exemplary embodiment. The grouping information illustrated in FIG. 5 illustrates a grouping of on-board monitor 200 in airplane 10 described in FIG. 2. In FIG. 5, for “group I,” an ID “0001” of on-board monitor 200A is associated with the seat number “2A,” an ID “0002” of on-board monitor 200B is associated with the seat number “2B,” an ID “0003” of on-board monitor 200C is associated with the seat number “2C,” an ID “0004” of on-board monitor 200D is associated with the seat number “3A,” an ID “0005” of on-board monitor 200E is associated with the seat number “3B,” and an ID “0006” of on-board monitor 200F is associated with the seat number “3C.”

For “group II,” an ID “0007” of on-board monitor 200 is associated with the seat number “2D,” an ID “0008” of on-board monitor 200 is associated with the seat number “2E,” an ID “0009” of on-board monitor 200 is associated with the seat number “2F,” an ID “0010” of on-board monitor 200 is associated with the seat number “3D,” an ID “0011” of on-board monitor 200 is associated with the seat number “3E,” and an ID “0012” of on-board monitor 200 is associated with the seat number “3F.”

For “group III,” an ID “00013” of on-board monitor 200 is associated with the seat number “2G,” an ID “0014” of on-board monitor 200 is associated with the seat number “2H,” an ID “0015” of on-board monitor 200 is associated with the seat number “2I,” an ID “0016” of on-board monitor 200 is associated with the seat number “3G,” an ID “0017” of on-board monitor 200 is associated with the seat number “3H,” and an ID “0018” of on-board monitor 200 is associated with the seat number “3I.”

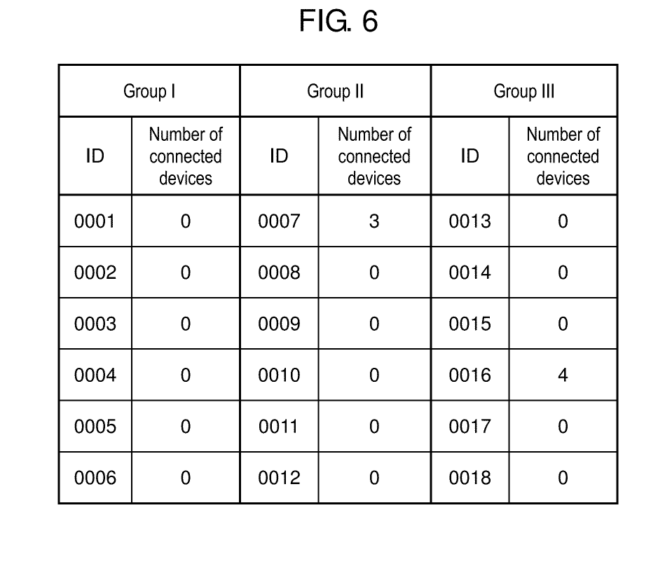

Next, the connection information is described. FIG. 6 is a diagram illustrating the connection information in the present exemplary embodiment. The connection information is information indicating a number of external devices such as smartphone 300 connected with on-board monitor 200 via Bluetooth. The grouping illustrated in FIG. 6 is the grouping of on-board monitor 200 in airplane 10 described in FIG. 2. In FIG. 6, for “group I,” to each of the IDs “0001,” “0002,” “0003,” “0004,” “0005,” “0006” of on-board monitor 200, a number of connected devices is “0.” For “group II,” to the ID “0007” of on-board monitor 200, the number of connected devices is “3.” To each of the IDs “0008,” “0009,” “0010,” “0011,” “0012” of on-board monitor 200, the number of connected devices is “0.” For “group III,” to the ID “0016” of on-board monitor 200, the number of connected devices is “4.” To each of the IDs “0013,” “0014,” “0015,” “0017,” “0018” of on-board monitor 200, the number of connected devices is “0.”

[1-4. Configuration of on-Board Monitor]

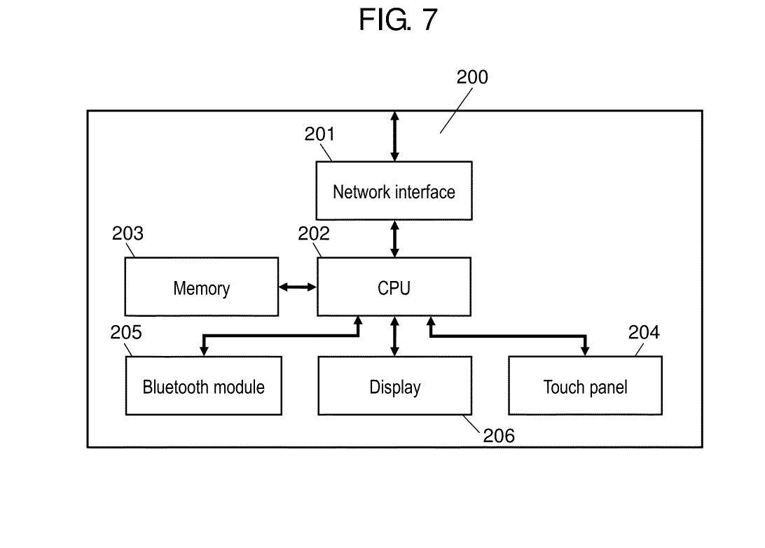

Next, a configuration of on-board monitor 200 is described. FIG. 7 is a block diagram of on-board monitor 200 in the present exemplary embodiment. On-board monitor 200 includes network interface 201, CPU 202, memory 203, touch panel 204, Bluetooth module 205, and display 206.

Network interface 201 is an interface by which CPU 202 communicate with server apparatus 100 via the network cable.

CPU 202 executes programs stored in memory 203 to perform various operations and information processing. CPU 202 is able to read from memory 103 or write to memory 103. In addition, CPU 202 communicates with server apparatus 100 via network interface 201.

Memory 203 stores programs to be executed by CPU 202 and operation results of CPU 202. Memory 203 is composed of a flash memory or a RAM.

Touch panel 204 is located on a surface of display 206. When the passenger touches a display output on display 206, touch panel 204 transmits information indicating a position touched on touch panel 204 to CPU 202. CPU 202 performs control in accordance with the transmitted information, and the passenger is able to operate intuitively.

Bluetooth module 205 includes a controller and an antenna for Bluetooth communication. Bluetooth module 205 receives a command from CPU 202 and executes a start operation of communication or a stop operation of communication, and transmits a communication state with smartphone 300 to CPU 202.

Display 206 displays various contents according to a command from CPU 202.

[1-5. Connection of Smartphone with on-Board Monitor]

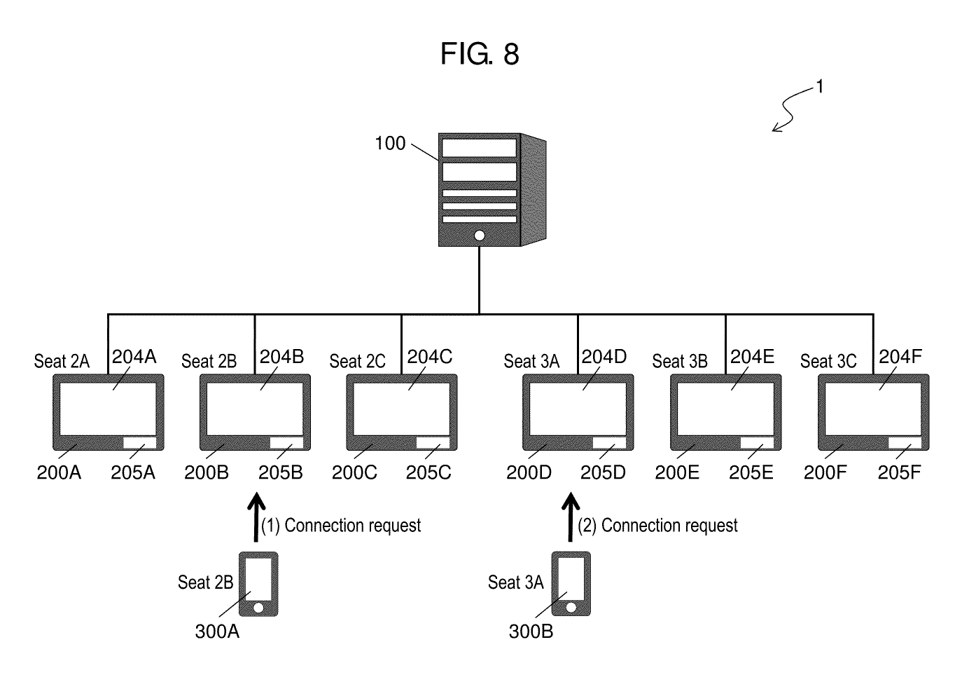

It is described for connection of smartphone 300 owned by the passenger with on-board monitor 200 in wireless communication system 1 configured as described above. FIG. 8 is a diagram describing connection of a smartphone with an on-board monitor in the first exemplary embodiment. As illustrated in FIG. 8, at the beginning, the passenger of the seat number “2B”, who owns smartphone 300A, requests to connect with on-board monitor 200B of the seat number “2B” via Bluetooth and smartphone 300A is connected to a network inside the airplane. Since then, the passenger of the seat number “3A”, who owns smartphone 300B, requests to connect with on-board monitor 200D of the seat number “3A” via Bluetooth and smartphone 300B is connected to the network inside the airplane. Operation of the above case is described.

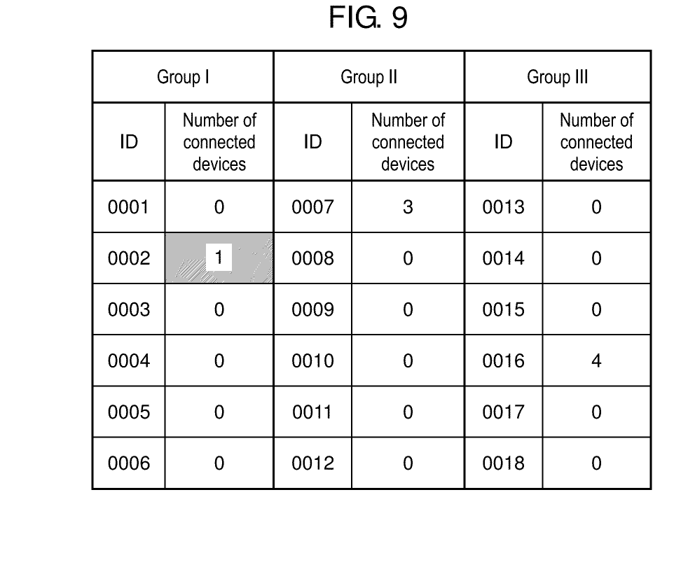

The passenger who owns smartphone 300A requests to cause on-board monitor 200B to connect with smartphone 300A via Bluetooth. On-board monitor 200B notifies server apparatus 100 that a request to connect with smartphone 300A via Bluetooth has been received. Server apparatus 100 determines on-board monitor 200 to be connected based on the connection information in FIG. 6 stored in data storage 104. In the connection information in FIG. 6, for “group I,” to each of all on-board monitors 200, the number of connected devices is “0.” Therefore, in “group I,” this is the first time that on-board monitor 200 connects with smartphone 300 via Bluetooth. When a connection via Bluetooth is the first time, server apparatus 100 causes on-board monitor 200B, which notified server apparatus 100 of the request, to connect with smartphone 300A, and updates the connection information. FIG. 9 is a diagram illustrating the connection information after the first time update. In FIG. 9, the number of connected devices of the ID “0002” of on-board monitor 200B in “group I” is updated from “0” to “1.”

Next, the passenger who owns smartphone 300B requests to cause on-board monitor 200D to connect with smartphone 300B via Bluetooth. On-board monitor 200D notifies server apparatus 100 that a request to connect with smartphone 300B via Bluetooth has been received. Server apparatus 100 determines on-board monitor 200 to be connected based on the connection information in FIG. 9 stored in data storage 104. In the connection information in FIG. 9, for “group I,” to the ID “0002” of on-board monitor 200B, the number of connected devices is “1.” Server apparatus 100 causes on-board monitor 200B, which has already established the connection, to connect with smartphone 300B, and updates the connection information.

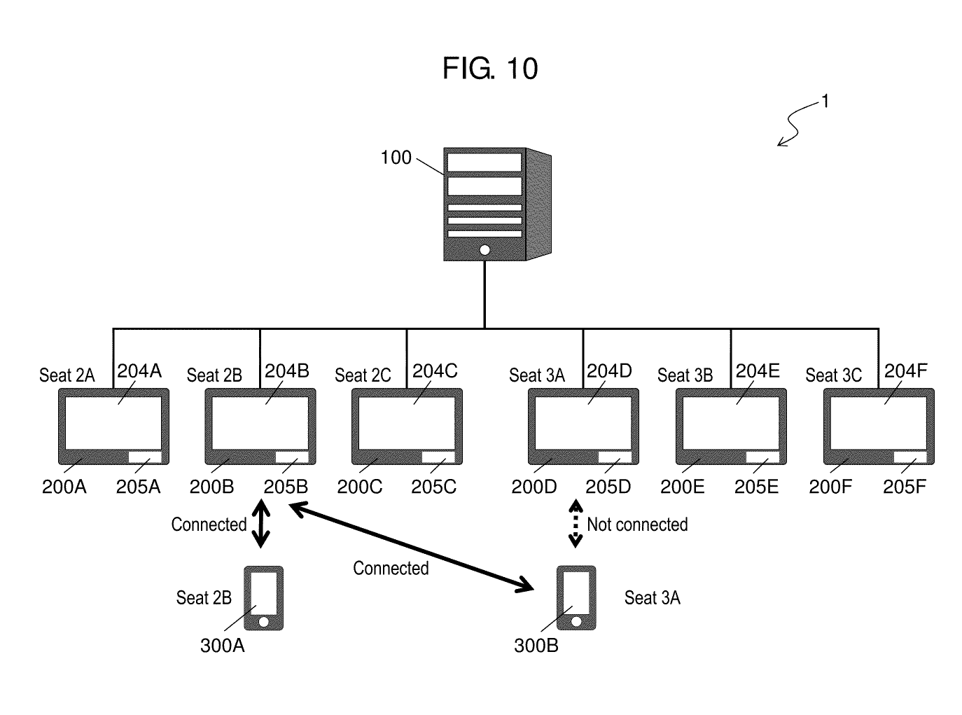

FIG. 10 is another diagram describing connection of the smartphone with the on-board monitor in the first exemplary embodiment. In FIG. 10, on-board monitor 200B connects with smartphones 300A and 300B via Bluetooth.

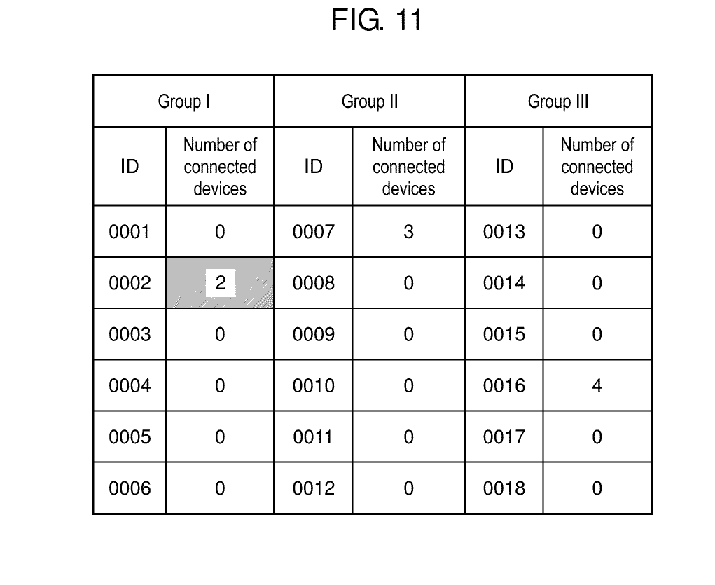

FIG. 11 is a diagram illustrating the connection information after the second time update. In FIG. 11, the number of connected devices of the ID “0002” of on-board monitor 200B in “group I” is updated from “1” to “2.”

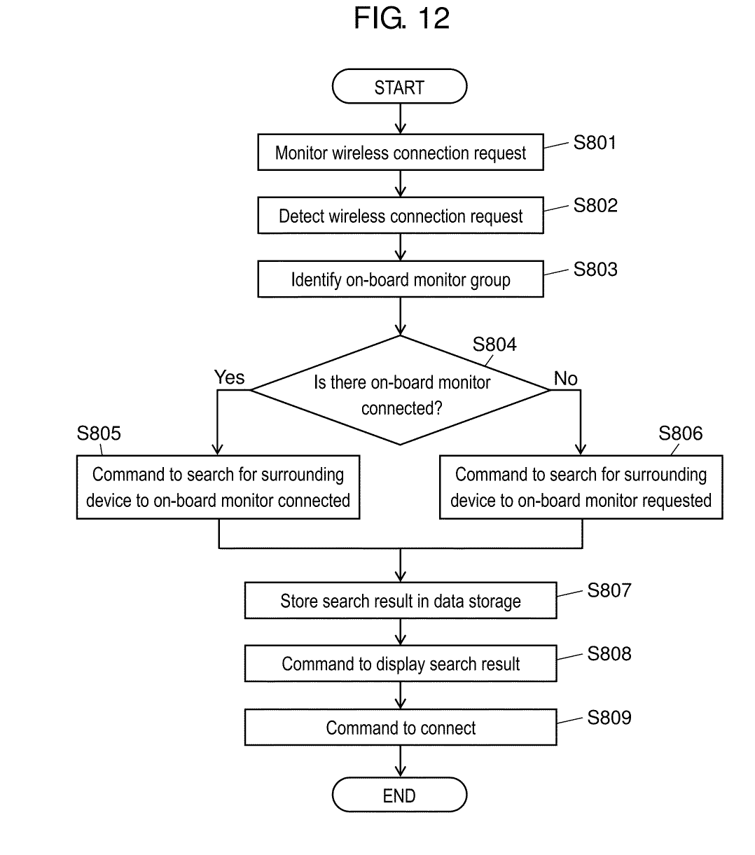

Next, connection of smartphone 300 with on-board monitor 200 is described using a flowchart. FIG. 12 is a flowchart describing the connection of the smartphone with the on-board monitor.

### [1-5-1. Acquisition of Connection Request]

(S801) CPU 102 in server apparatus 100 monitors a connection request from touch panel 204 on on-board monitor 200.

(S802) The passenger operates touch panel 204 on on-board monitor 200 located at the passenger's seat and the like to input a request to connect with smartphone 300 via Bluetooth, when considering to connect one's own smartphone 300 to the network inside the airplane.

When receiving the request by the passenger, CPU 202 in on-board monitor 200 transmits a request signal to server apparatus 100 via network interface 201. On-board monitor 200 stores an ID for identifying on-board monitor 200 in memory 203. CPU 202 transmits the ID of on-board monitor 200 with the request signal to server apparatus 100 at the same time. In the example of FIG. 8, the ID of on-board monitor 200B is “0002,” and the ID of on-board monitor 200D is “0004.” CPU 102 in server apparatus 100 detects the request signal from on-board monitor 200.

[1-5-2. Identification of Group of on-Board Monitor]

(S803) CPU 102 in server apparatus 100, when receiving the request signal from on-board monitor 200, identifies a group of on-board monitor 200 transmitted the request signal. CPU 102 in server apparatus 100 identifies the group of on-board monitor 200 inputted the request based on the grouping information in data storage 104 and received the ID of on-board monitor 200. Here, in the example of FIG. 8, the group of on-board monitors 200B, 200D is “group I,” so that CPU 102 identifies that the group of on-board monitor 200 transmitted the request signal is “group I.”

The group of on-board monitor 200 transmitted the request signal is identified for performing subsequent processing to the other on-board monitor in the same group.

### [1-5-3. Determination of Connection Destination]

(S804) Server apparatus 100 determines whether or not there is on-board monitor 200 connected with smartphone 300 in the group including on-board monitor 200 transmitted the request signal, based on the connection information and the grouping information stored in data storage 104 in server apparatus 100. CPU 102 in server apparatus 100 checks the connection information of on-board monitor 200 of the corresponding group, and determines whether or not there is on-board monitor 200 which connected with smartphone 300. In the example of FIG. 8, if on-board monitor 200 that transmitted the request is on-board monitor 200B, there is no on-board monitor 200 which connected with smartphone 300. And if on-board monitor 200 that transmitted the request is on-board monitor 200D, there is on-board monitor 200 which connected with smartphone 300.

Here, Bluetooth communication is performed in a unit called Piconet. The Piconet is configured in one on-board monitor 200 which is a master and up to seven smartphones 300 which are slaves. Therefore, even if there is on-board monitor 200 which connected with seven smartphones 300, it is not determined that on-board monitor 200 connected with smartphone 300. This is because it is not possible that this on-board monitor 200 connects with any more smartphones 300.

CPU 102 in server apparatus 100, when determining that there is on-board monitor 200 that connected with smartphone 300 in the group including on-board monitor 200 transmitted the request signal (S804: Yes), advances processing to step S805, and CPU 102 in server apparatus 100, when determining that there is no on-board monitor 200 that connected with smartphone 300 in the group including on-board monitor 200 transmitted the request signal (S804: No), advances the processing to step S806.

(S805) CPU 102 issues a search command for surrounding smartphone 300 to on-board monitor 200 connected to the network. As the example of FIG. 8, when on-board monitor 200 connected to the network is on-board monitor 200B, CPU 102 issues the search command to on-board monitor 200B.

Incidentally, considering a possibility of connection failure due to low communication quality between on-board monitor 200B and smartphone 300B, CPU 102 may issue the search command to on-board monitor 200D transmitted the request signal with the search command to on-board monitor 200B at the same time.

(S806) CPU 102 issues a search command for surrounding smartphone 300 to on-board monitor 200 transmitted the request signal. As the example of FIG. 8, when on-board monitor 200 transmitted the request signal is on-board monitor 200B, CPU 102 issues the search command to on-board monitor 200B.

Incidentally, in step S806, CPU 102 may issue the search command to another on-board monitor 200 instead of to on-board monitor 200 transmitted the request signal. For example, in the same group, CPU 102 may issue the search command to on-board monitor 200 that is a center position in the group. For determination of on-board monitor 200 that is the center position in the group, the position is identified from the seat number of on-board monitor 200 included in the same group, and a centroid position of on-board monitor 200 included in the same group is calculated, and on-board monitor 200 closest to the centroid position may be selected. In addition, determination of on-board monitor 200 that is the center position of the group is not limited to this.

### [1-5-4. Storage of Search Result]

(S807) CPU 202 searches for surrounding smartphone 300, and transmits information indicating smartphone 300 detected as a search result to server apparatus 100. When CPU 202 detects a plurality of smartphones 300, CPU 202 transmits the information of all smartphones 300 detected to server apparatus 100. CPU 102 in server apparatus 100 stores the search result received in data storage 104. As the example of FIG. 8, when CPU 202 in on-board monitor 200B detects smartphone 300A, CPU 202 transmits the information indicating smartphone 300A to server apparatus 100, and when CPU 202 in on-board monitor 200A detects smartphone 300B, CPU 202 transmits the information indicating smartphone 300B to server apparatus 100.

### [1-5-5. Display Command of Search Result]

(S808) CPU 102 in server apparatus 100 commands on-board monitor 200 transmitted the request signal to display the search result stored in data storage 104 in step S807. As the example of FIG. 8, if on-board monitor 200 transmitted the request signal is on-board monitor 200B, on-board monitor 200B detects smartphone 300A, so that CPU 102 commands on-board monitor 200B to display “smartphone 300A” as the search result. When on-board monitor 200 transmitted the request signal is on-board monitor 200D, on-board monitor 200D detects smartphone 300B, so that CPU 102 commands on-board monitor 200D to display “smartphone 300B” as the search result.

Incidentally, a display method may be displaying on display 206 on on-board monitor 200, however, it is not limited to this.

(S809) When the passenger operates touch panel 204 to select the corresponding smartphone 300 from the search result displayed, on-board monitor 200 connects with smartphone 300 selected by the passenger, via Bluetooth. After the connection is established via Bluetooth, CPU 102 updates the connection information. In the example of FIG. 8, the passenger of the seat number “2A” operates touch panel 204 to select smartphone 300A. The passenger of the seat number “3A” operates touch panel 204 to select smartphone 300B.

When on-board monitor 200 connects with smartphone 300 that is able to communicate via Bluetooth, if on-board monitor 200 connects one-to-one with smartphone 300 at each seat, for example, adjacent two one-to-one connections between smartphone 300 and on-board monitor 200 via Bluetooth interfere with each other. Therefore, as described above, when on-board monitor 200 connects with smartphone 300 that is able to communicate via Bluetooth, server apparatus 100 manages a connection destination. And server apparatus 100 cause on-board monitor 200 connected with smartphone 300 in the same group to newly connect with smartphone 300, so that the Piconet can be efficiently configured. A communication channel between on-board monitor 200 and each smartphone 300 in the same Piconet is shared by time division multiplex. Accordingly, interference can be avoided. Since each of communication channels tends to interfere with each other when there are many one-to-one connections via Bluetooth, throughput is generally increased by selecting a “short packet” mode that retransmission cost is small. However, transmission efficiency is not necessarily high because a ratio of an information byte in a packet is low. On the other hand, in the Piconet that is one-to-many connections via Bluetooth, since each of the communication channels shares by multiplexing time division slots, packet loss by the interference is small even when using a “long packet” mode.

With the wireless communication system of the present exemplary embodiment, by controlling the wireless communication apparatus connected in a Bluetooth communication area, the wireless communication control method and the wireless communication control system can be provided which provide a low interference, highly efficient wireless quality.

### [1-6. Effects]

As described above, the wireless communication control method of the present exemplary embodiment is a wireless communication control method controlling communication between a first wireless communication apparatus and a first external device, and controlling communication between a second wireless communication apparatus and a second external device, by a server apparatus, the method including receiving a connection request to the first external device from the first wireless communication apparatus, and causing the first external device to connect with the second wireless communication apparatus if the second wireless communication apparatus has been connected with the second external device upon receiving the connection request.

With this configuration, if a plurality of smartphones 300 is connected with the wireless communication system, the same on-board monitor connects with a plurality of smartphones 300 and the same Piconet is preferentially configured. Therefore, even when each of the plurality of on-board monitors 200 that is a master in Bluetooth is located overlapping each communication area, by utilizing a function of master-slave operation in Bluetooth, interference can be reduced of wireless communication between smartphones 300 connected with the wireless communication system. That is, in a situation in which there is a plurality of wireless communication apparatuses, the interference is reduced between the wireless communication apparatuses, and communication quality can be improved.

### Second Exemplary Embodiment

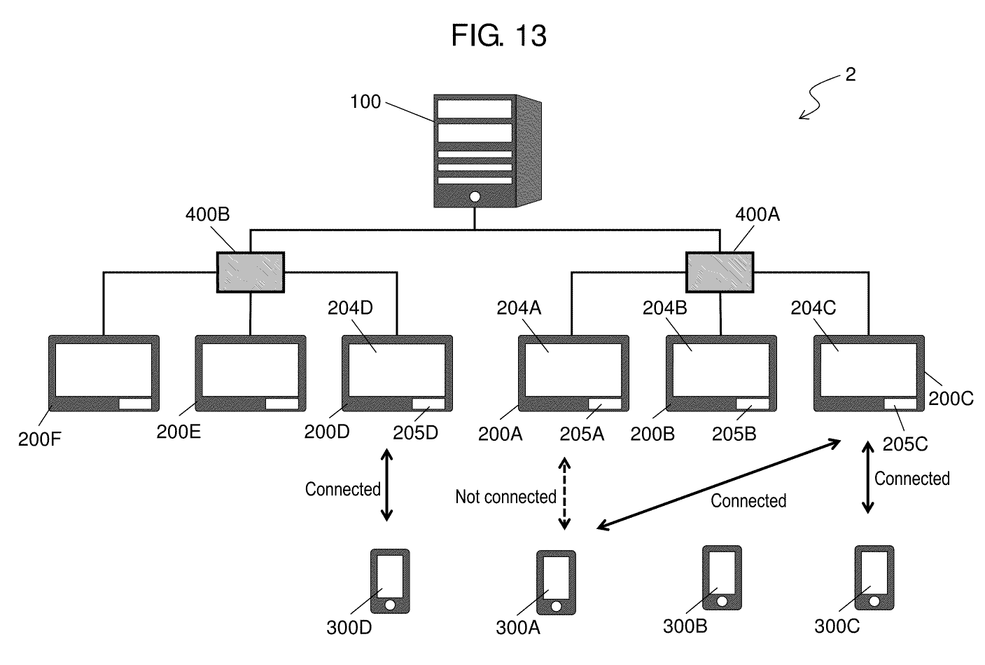

A second exemplary embodiment is described below with reference to FIG. 13. A point in which the present exemplary embodiment is different from the first exemplary embodiment is that server apparatus 100 and on-board monitor 200 configuring wireless communication system 2 are connected via repeaters 400A, 400B, and that a grouping of on-board monitor 200 is different that of from the first exemplary embodiment. The configurations of server apparatus 100, on-board monitor 200 are the same as those of the first exemplary embodiment, so that the description of them is omitted.

### [2-1. Configuration]

FIG. 13 is a block diagram of a wireless communication system in a second exemplary embodiment. Wireless communication system 2 includes server apparatus 100, on-board monitors 200A, 200B, 200C, 200D, 200E, 200F, and repeaters 400A, 400B. Repeater 400A is disposed between server apparatus 100 and on-board monitors 200A-200C, and repeater 400B is disposed between server apparatus 100 and on-board monitors 200D-200F, and repeaters 400A, 400B are rooters that assign IP address for on-board monitor 200, perform shaping signals from server apparatus 100, and the like. On-board monitors 200 are divided into partial networks by repeaters 400A, 400B. In the present exemplary embodiment, the grouping of on-board monitors 200 is performed for each of the partial networks divided by repeaters 400A, 400B. In the network configuration of FIG. 13, on-board monitors 200A-200C configure one group, and on-board monitors 200D-200F configure another one group. Grouping information in the present exemplary embodiment is such a group configuration. The grouping information is stored in data storage 104.

[2-2. Connection of Smartphone with on-Board Monitor]

For wireless communication system 2 configured as described above, connection of the smartphone with the on-board monitor is described below. Operation of wireless communication system 2 of the present exemplary embodiment is the same as the operation of FIG. 12 described in the first exemplary embodiment.

In FIG. 13, on-board monitor 200C has already connected with smartphone 300C and on-board monitor 200D has already connected with smartphone 300D. In this state, a passenger requests to cause on-board monitor 200A to connect with smartphone 300A. Then, a request signal is transmitted to server apparatus 100. Here, server apparatus 100 identifies a group including on-board monitor 200A transmitted the request signal, based on the grouping information. Then, server apparatus 100 determines that on-board monitor 200 which connected with the smartphone is on-board monitor 200C in the group identified. Incidentally, on-board monitor 200D is not detected here since it belongs to a different group from on-board monitor 200A. Server apparatus 100 issues a search command to on-board monitor 200C. Subsequent operations are the same as those described in the first exemplary embodiment.

### Other Exemplary Embodiment

The exemplary embodiments have been described above as examples of technique of the present disclosure. However, the technique in the present disclosure is not limited thereto, and it is also possible to apply to an exemplary embodiment in which modification, replacement, addition, omission are appropriately performed. In addition, it is possible to make a new exemplary embodiment by combining elements described in the above exemplary embodiments.

Therefore, the other exemplary embodiment is exemplified below.

In the configuration of the above exemplary embodiments, it has been described that the connection between server apparatus 100 and on-board monitor 200 is a wired network cable. By using the network cable, an effect is expected that the connection between server apparatus 100 and each on-board monitor 200 is stabilized. However, the connection is not limited to the network cable. For example, wireless connection may be used. By wireless connection, the degree of freedom in arrangement of on-board monitors 200 is increased.

In the above exemplary embodiment, as the grouping information, the seat number has been used for the position of on-board monitor 200. When on-board monitors 200 are located corresponding to the seats, an amount of information can be reduced by using the seat number. However, the position of on-board monitor 200 is not limited to the seat number. For example, by using coordinates of a coordinate system to be set in an airplane for the position, identification of the position is possible even when on-board monitor 200 is not located regularly.

In the above exemplary embodiments, it has been described that the passenger inputs the wireless communication request from the touch panel. For input of the wireless communication request, anything may be used as far as the passenger is able to input the connection request between smartphone 300 and on-board monitor 200, and it is not limited to the touch panel. For example, NFC (Near Field Communication) may be used that is one of short range wireless communication systems. By using the NFC, it is also possible to transmit a Bluetooth MAC address of smartphone 300 to on-board monitor 200, so that the passenger may not select smartphone 300.

In the above exemplary embodiments, it has been described that a number of on-board monitors 200 to connect with smartphone 300 in one group is one; however, the number is not limited to one. For example, when there are on-board monitors 200B, 200C that connected with smartphone 300 in one group and the request signal is transmitted from on-board monitor 200A, the search command for smartphone 300 may be issued to on-board monitor 200B that is positioned at a place closest from on-board monitor 200A.

In the above exemplary embodiments, the search result of smartphone 300 by on-board monitor 200 has been stored in server apparatus 100. However, the search result does not necessarily need to be stored in server apparatus 100. The search result may be displayed by directly transmitting the search result from on-board monitor 200 that has searched for smartphone 300 to on-board monitor 200 on which the search result should be displayed.

In the above exemplary embodiments, it has been described that the passenger owns smartphone 300. However, not limited to smartphone 300, it may be an external device such as a personal computer, and a tablet terminal.

As described above, the exemplary embodiments have been described as examples of the technique of the present disclosure. For this purpose, the accompanying drawings and the detailed description have been provided.

Accordingly, in the elements described in the accompanying drawings and the detailed description, there may be included not only essential elements for solving the problem but also non-essential elements for solving the problem, to illustrate the above technique. Therefore, it should not be certified that those non-essential elements are essential immediately, with the fact that those non-essential elements are described in the accompanying drawings and the detailed description.

Further, since the above described exemplary embodiments are intended to illustrate the technique of the present disclosure, various modifications, substitutions, additions, omissions and the like can be performed within the scope of the claims or the scope of the equivalents of the claims.

What is claimed is:

1. A wireless communication control method controlling communication between a first wireless communication apparatus and a first external device, and controlling communication between a second wireless communication apparatus and a second external device, by a server apparatus, the wireless communication control method comprising:
receiving a connection request to the first external device from the first wireless communication apparatus; and
causing the first external device to connect with the second wireless communication apparatus if the second wireless communication apparatus has been connected with the second external device upon receiving the connection request.

2. The wireless communication control method according to claim 1, wherein
the first wireless communication apparatus and the second wireless communication apparatus belong to one group.

3. The wireless communication control method according to claim 1, further comprising causing the first external device to connect with the first wireless communication apparatus if the second wireless communication apparatus has not been connected with the second external device upon receiving the connection request.

4. The wireless communication control method according to claim 1, wherein
the server apparatus further controls communication between each of a plurality of wireless communication apparatuses and each of a plurality of external devices,
the first wireless communication apparatus, the second wireless communication apparatus and the plurality of wireless communication apparatuses are located within a predetermined range and belong to one group, and
the wireless communication control method further comprising causing the first external device to connect with an apparatus that is closest to a center of the group among the first wireless communication apparatus, the second wireless communication apparatus, and the plurality of wireless communication apparatuses if the second wireless communication apparatus has not been connected with the second external device and each of the plurality of wireless communication apparatuses has not been connected with each of the plurality of external devices, upon receiving the connection request.

5. The wireless communication control method according to claim 1, wherein
the server apparatus is integrally formed with the first wireless communication apparatus.

6. A wireless communication control system comprising:
a first wireless communication apparatus including an input device configured to input a wireless connection request of a first external device;
a second wireless communication apparatus; and
a server apparatus configured to control communication between the first wireless communication apparatus and the first external device, and to control communication between the second wireless communication apparatus and the second external device,
wherein the server apparatus causes the first external device to connect with the second wireless communication apparatus if the second wireless communication apparatus has been connected with the second external device when the input device of the first wireless communication apparatus receives the wireless connection request.

7. The wireless communication control system according to claim 6, wherein
the first wireless communication apparatus and the second wireless communication apparatus belong to one group.

8. The wireless communication control system according to claim 6, wherein
the server apparatus causes the first external device to connect with the first wireless communication apparatus if the second wireless communication apparatus has not been connected with the second external device upon receiving the connection request.

9. The wireless communication control system according to claim 6, wherein
the server apparatus further controls communication between each of a plurality of wireless communication apparatuses and each of a plurality of external devices,
the first wireless communication apparatus, the second wireless communication apparatus and the plurality of wireless communication apparatuses are located within a predetermined range and belong to one group, and
the server apparatus causes the first external device to connect with an apparatus that is closest to a center of the group among the first wireless communication apparatus, the second wireless communication apparatus, and the plurality of wireless communication apparatuses if the second wireless communication apparatus has not been connected with the second external device and each of the plurality of wireless communication apparatuses has not been connected with each of the plurality of external devices upon receiving the connection request.

10. The wireless communication control system according to claim 6, further comprising a repeater between the server apparatus and the first wireless communication apparatus, the second wireless communication apparatus, and a plurality of wireless communication apparatuses, wherein
the server apparatus further controls communication between each of a plurality of wireless communication apparatuses and each of the plurality of external devices,
the first wireless communication apparatus, the second wireless communication apparatus, and the plurality of wireless communication apparatuses belong to one group, and
the server apparatus causes the first external device to connect with an apparatus that is closest to the center of the group among the first wireless communication apparatus, the second wireless communication apparatus, and the plurality of wireless communication apparatus if the second wireless communication apparatus has not been connected with the second external device and each of the plurality of wireless communication apparatuses has not been connected with each of the plurality of external devices upon receiving the connection request.

11. The wireless communication control system according to claim 6, wherein
the server apparatus is integrally formed with the first wireless communication apparatus.

12. The wireless communication control system according to claim 6, wherein
the first wireless communication apparatus and the second wireless communication apparatus are disposed without separating by an aisle.
